(19) United States
(12) Patent Application Publication
(10) Pub. No.: US 2018/0107687 A1
(43) Pub. Date: Apr. 19, 2018

(54) LEARNING DATA CREATION SUPPORTING METHOD

(71) Applicant: Panasonic Intellectual Property Corporation of America, Torrance, CA (US)

(72) Inventors: TORU TANIGAWA, Osaka (JP); YUKIE SHODA, Osaka (JP); TETSUJI FUCHIKAMI, Osaka (JP)

(21) Appl. No.: 15/713,110

(22) Filed: Sep. 22, 2017

(30) Foreign Application Priority Data
Oct. 14, 2016 (JP) 2016-202867
Jun. 19, 2017 (JP) 2017-119847

(51) Int. Cl. G06F 17/30; G06T 1/00; G06T 1/60

(52) U.S. Cl. CPC G06F 17/30265; G06T 1/60; G06T 1/0007; G06F 17/3028

(57) ABSTRACT

A method includes: recognizing, based on a taken image obtained by taking an image of an object, a description of an attribute of the object and the type of act of the object; storing the recognized description of the attribute of the object and type of act of the object in a database; judging whether the frequency of occurrence of an act of the recognized type is less than a previously set threshold value by referring to the database; and outputting, if a judgment is made that the frequency of occurrence is less than the threshold value, an instruction to create, as learning data, computer graphics (CG) data describing a state in which the object having the attribute whose description is different from the recognized description of the attribute is doing the act of the recognized type based on the taken image.

### BACKGROUND

### 1. Technical Field

The present disclosure relates to a method and a device that support creation of learning data and a recording medium on which a program that supports creation of learning data is recorded.

### 2. Description of the Related Art

The accuracy of recognition or detection of an object, such as a person, in an image is increased by a technology such as deep learning. Recognition in deep learning requires a large amount of learning data. As learning data, an image and a correct label for an object to be recognized which is in the image are needed. In Japanese Unexamined Patent Application Publication No. 2013-161295, a technology of attaching a correct label is described. Moreover, making use of CG data as an image of learning data is known (see, for example, Japanese Unexamined Patent Application Publication No. 2010-211732).

### SUMMARY

However, with the method described in Japanese Unexamined Patent Application Publication No. 2013-161295, it is impossible to create appropriate learning data.

One non-limiting and exemplary embodiment provides a learning data creation supporting method and so forth that can create appropriate learning data.

In one general aspect, the techniques disclosed here feature a method including: recognizing, based on a taken image obtained by taking an image of an object, a description of an attribute of the object and the type of act of the object; storing the recognized description of the attribute of the object and type of act of the object in a database; judging whether the frequency of occurrence of an act of the recognized type is less than a previously set threshold value by referring to the database; and outputting, if a judgment is made that the frequency of occurrence is less than the threshold value, an instruction to create, as learning data, computer graphics (CG) data describing a state in which the object having the attribute whose description is different from the recognized description of the attribute is doing the act of the recognized type based on the taken image.

With the learning data creation supporting method of the present disclosure, it is possible to create appropriate learning data.

It should be noted that general or specific embodiments may be implemented as a system, a method, an integrated circuit, a computer program, a computer-readable recording medium such as a CD-ROM, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a configuration diagram depicting the configuration of a learning data creating system in an embodiment;

FIG. 2 is a diagram depicting an example of a screen which is displayed by a presenting unit in the embodiment;

FIG. 3 is a diagram depicting an example of recognition results which are stored in a recognition result storing unit in the embodiment;

FIG. 4 is a diagram depicting an example of the frequency of occurrence of an act which is stored in the recognition result storing unit in the embodiment;

FIG. 5 is a diagram for explaining processing of a CG creating device in the embodiment;

FIG. 6 is a flowchart illustrating processing operations of the learning data creating system in the embodiment;

FIG. 7A is a flowchart illustrating a learning data creation supporting method according to an aspect of the present disclosure; and

FIG. 7B is a block diagram depicting the functional configuration of a learning data creation supporting device according to an aspect of the present disclosure.

### DETAILED DESCRIPTION

### (Underlying Knowledge Forming Basis of the Present Disclosure)

The inventor has found out that the method of Japanese Unexamined Patent Application Publication No. 2013-161295 described in the “Description of the Related Art” section has the following problem.

As described earlier, learning by deep learning requires a large number of images as learning data. Moreover, in recognition, detection, or prediction of a person in an image by using the learning result, recognition of not only an attribute of the person but also an act of the person, for example, is needed. However, although it is easy to collect many images indicating acts which a person frequently does on a daily basis, such as walking, as learning data, it is difficult to collect images of peculiar acts as learning data. The peculiar acts are, for example, “running out into the street”, “fall”, and “shoplifting”. In Japanese Unexamined Patent Application Publication No. 2013-161295 described above, correct labels are attached to objects to be recognized in the collected images, but learning data cannot be generated even for peculiar acts that have not been collected as images. Therefore, as in the method of Japanese Unexamined Patent Application Publication No. 2010-211732 described above, generating an image of a peculiar act by using CG data is possible. In Japanese Unexamined Patent Application Publication No. 2010-211732, it is possible to increase the number of variations of learning data by making use of CG data.

However, since there are already a large amount of learning data as images of real scenes, it is not necessary to add images of real scenes of that learning data by CG and images of acts whose frequency of occurrence is low in real scenes have to be created by CG, but Japanese Unexamined Patent Application Publication No. 2010-211732 makes no mention of a method of making a judgment as to whether or not the creation by CG has to be performed. That is, it is sometimes difficult to make a judgment as to which act is a peculiar act even by using the method of Japanese Unexamined Patent Application Publication No. 2010-211732 described above, which makes it impossible to collect appropriate learning data.

Moreover, the frequency of occurrence of a peculiar act such as “running out into the street”, “fall”, or “shoplifting” is low and there is not enough learning data. Thus, if there is not enough learning data of these peculiar acts, the accuracy of recognition of these peculiar acts by a recognizing device using deep learning or the like is not that high. Therefore, it is difficult to automatically extract learning data of peculiar acts for generation of CG data.

To solve such a problem, a method according to an aspect of the present disclosure includes: recognizing, based on a taken image obtained by taking an image of an object, a description of an attribute of the object and the type of act of the object; storing the recognized description of the attribute of the object and type of act of the object in a database; judging whether the frequency of occurrence of an act of the recognized type is less than a previously set threshold value by referring to the database; and outputting, if a judgment is made that the frequency of occurrence is less than the threshold value, an instruction to create, as learning data, computer graphics (CG) data describing a state in which the object having the attribute whose description is different from the recognized description of the attribute is doing the act of the recognized type based on the taken image. For instance, the taken image may be an image obtained by taking an image of a person as the object, and, in the recognizing, a description of at least one of an age, gender, physique, clothing, belongings, and background of the person may be recognized as the description of the attribute.

As a result, a judgment as to whether or not the frequency of occurrence of an act of the type recognized based on the taken image is less than the threshold value is made. This makes it possible to automatically extract a taken image in which the object which is a person, for example, is doing an act of a type whose frequency of occurrence is low, such as “running out into the street”, “fall”, or “shoplifting”, that is, a peculiar act. Furthermore, since an instruction to create CG data is output, it is possible to generate, as learning data, CG data describing a state in which a person having the attribute whose description is different from the description of the attribute of the person in the taken image is doing a peculiar act. That is, it is possible to create, as learning data, a large amount of CG data describing states in which the persons with different descriptions of the attribute are doing the peculiar act. This makes it possible to create and collect appropriate learning data for peculiar acts and so forth.

Moreover, the method may further include learning the relationship between an image described by the CG data and the description of the attribute of the object and the type of act of the object by using the CG data created in response to the output of the instruction.

As a result, since learning, such as deep learning, using the created CG data is performed, even when an object whose image has not been taken before is doing a peculiar act, it is possible to increase the accuracy of recognition of a taken image of the object.

In addition, the method may further include: presenting the recognized description of the attribute of the object and type of act of the object as recognition results; and accepting change of at least one of the description of the attribute and the type of act which are included in the presented recognition results, in the storing, the changed recognition results may be stored in the database, in the judging, a judgment as to whether or not the frequency of occurrence of an act of a type included in the changed recognition results is less than the threshold value may be made, and, in the outputting, an instruction to create the CG data describing a state in which the object having the attribute whose description is different from the description of the attribute included in the changed recognition results is doing the act of the type included in the changed recognition results may be output.

As a result, even when there is an error in the recognition results, it is possible to correct the error by change. Moreover, even when the type of act is recognized as “unknown” or “others”, it is possible to correct “unknown” or “others” to a correct type of act. This makes it possible to create and collect more appropriate CG data and thereby increase the accuracy of recognition of peculiar acts.

Furthermore, the taken image may include a form image indicating the form and brightness of a person as the object and a distance image indicating the distance to each body part in the person, and, in the recognizing, recognition may be performed based on the form image and skeleton information indicating the skeleton or joints of the person and generated from the distance image.

As a result, since recognition is performed based on the skeleton information, it is possible to recognize the type of act of a person more appropriately.

In addition, the method may further include outputting the skeleton information to a device that creates the CG data.

As a result, since the skeleton information is output, it is possible to use the skeleton information in creating the CG data and create appropriate CG data by attaching various attributes to the skeleton or joints of a person indicated by the skeleton information.

Hereinafter, embodiments will be described specifically with reference to the drawings.

It is to be noted that all the embodiments which will be described below are comprehensive or specific examples. The numerical values, shapes, materials, component elements, placement positions and connection configurations of the component elements, steps, order of steps, and so forth which will be described in the following embodiments are mere examples and are not meant to limit the present disclosure. Moreover, of the component elements in the following embodiments, a component element which is not described in an independent claim describing the broadest concept is described as an arbitrary component element.

Furthermore, the drawings are schematic diagrams and do not present precise illustration. In the drawings, the same component members are identified with the same reference characters.

### (Embodiment)

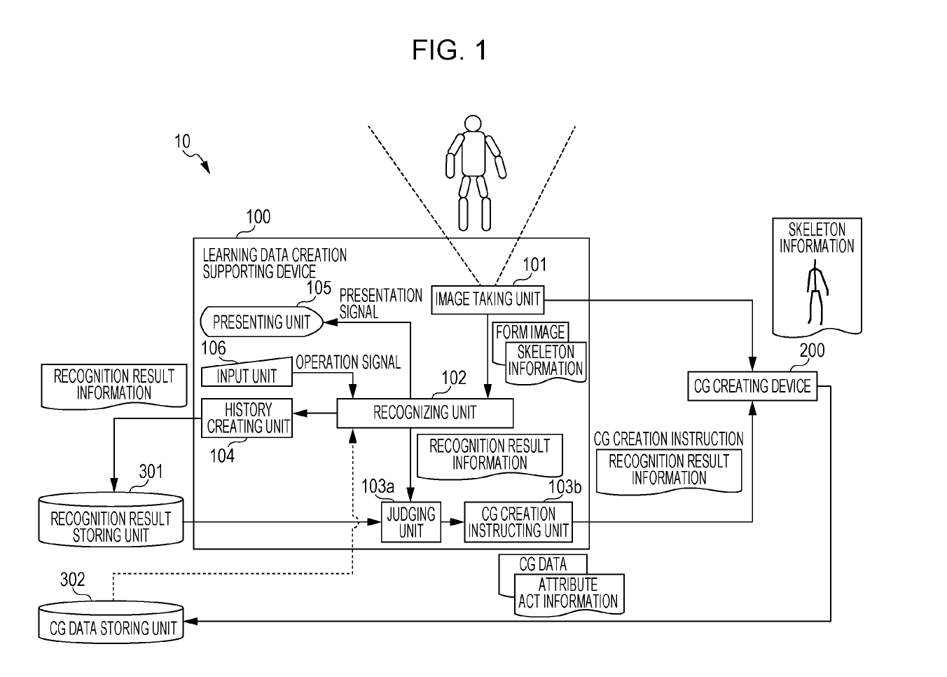

FIG. 1 is a configuration diagram depicting the configuration of a learning data creating system in the present embodiment.

A learning data creating system 10 in the present embodiment is a system configured with at least one computer that creates learning data which is used for mechanical learning such as deep learning. The learning data describes an image of an object and is used to learn the relationship between a description of an attribute of the object and the type of act of the object and the image. The object is a person, for example. Hereinafter, explanations will be given on the assumption that an object whose image is taken is a person. That is, by using a recognition model generated by mechanical learning based on this learning data, based on an image of a person, a description of an attribute of the person and the type of act of the person can be recognized, detected, or predicted.

Such a learning data creating system 10 includes a learning data creation supporting device 100, a CG creating device 200, a recognition result storing unit 301, and a CG data storing unit 302.

The learning data creation supporting device 100 is a device that supports creation of learning data and includes an image taking unit 101, a recognizing unit 102, a judging unit 103a, a CG creation instructing unit 103b, a history creating unit 104, a presenting unit 105, and an input unit 106.

The image taking unit 101 takes an image of an object and thereby obtains a taken image including the object. For example, the image taking unit 101 takes an image of a person as the object. Specifically, in taking an image of the object, the image taking unit 101 obtains a taken image including a form image indicating the form and brightness of the person as the object and a distance image indicating the distance to each body part in the person. Furthermore, the image taking unit 101 generates skeleton information indicating the skeleton or joints of the person from the distance image. Incidentally, the skeleton information indicates the three-dimensional position of the skeleton or joints. The image taking unit 101 outputs the skeleton information to the CG creating device 200 that is a device creating computer graphics (CG) data.

More specifically, the image taking unit 101 includes an image sensor such as a charge-coupled device (CCD) or a complementary metal oxide semiconductor (CMOS) and a distance image sensor. The image sensor takes an image of the object and thereby generates a form image showing the form of the person by at least brightness. The form image may show the form of the person by brightness and a color difference and may be an image expressed by RGB. The distance image sensor determines the distance from the distance image sensor to the object by illuminating the object with light of an infrared light-emitting diode (LED), for example, and measuring the time from when illumination is performed until when the light returns after being reflected from the object. That is, the distance image sensor generates a distance image indicating the distance from the image taking unit 101 to each body part in the object by taking an image of the object.

In the present embodiment, the image taking unit 101 includes the distance image sensor, but the image taking unit 101 may not include this distance image sensor and may obtain only a form image as a taken image by taking an image of the object. In this case, the image taking unit 101 outputs only the form image to the recognizing unit 102 as the taken image without generating the skeleton information. Moreover, in the present embodiment, the learning data creation supporting device 100 includes the image taking unit 101, but the learning data creation supporting device 100 may not include the image taking unit 101. In this case, the learning data creation supporting device 100 may obtain a taken image from the image taking unit 101 provided outside the learning data creation supporting device 100 and may obtain at least one of the form image, the distance image, and the skeleton information.

The presenting unit 105 is configured with, for example, a liquid-crystal display or organic electroluminescence (EL) and displays an image in accordance with a presentation signal from the recognizing unit 102. Such a presenting unit 105 presents a description of an attribute of the object, such as a person, and the type of act of the object, which were recognized by the recognizing unit 102, as recognition results.

The input unit 106 is configured with an input device such as a keyboard, a mouse, or a touch panel. Such an input unit 106 accepts an input operation performed by the user of the learning data creation supporting device 100 and outputs, to the recognizing unit 102, an operation signal which is a signal in accordance with the accepted input operation.

The recognizing unit 102 recognizes a description of an attribute of the object such as a person and the type of act of the object based on the above-described taken image. Specifically, the recognizing unit 102 obtains the form image and the skeleton information generated by the image taking unit 101 and inputs the form image and the skeleton information to the recognition model, thereby recognizing a description of an attribute of a person in the form image and the type of act of the person. In the present embodiment, the recognizing unit 102 obtains the taken image including the form image and the skeleton information from the image taking unit 101, but the recognizing unit 102 may obtain only the form image as the taken image. That is, it is necessary simply to input only the form image, which is image data, taken by the image taking unit 101 to the recognizing unit 102, and input of the skeleton information to the recognizing unit 102 does not necessarily have to be performed. In this case, the recognizing unit 102 recognizes a description of an attribute of the object such as a person and the type of act of the object based only on the form image obtained from the image taking unit 101 without using the skeleton information. For example, the recognizing unit 102 recognizes a description of at least one of the age, gender, physique, clothing, belongings, and background of the person as the above-described description of the attribute. A description of the background is, for example, “sunny weather”, “cloudy weather”, or “indoors”. A description of the physique is, for example, the numerical values of a height and weight. Moreover, the recognizing unit 102 recognizes, for example, “walking”, “making sure it's a proper article”, “fall”, “running out into the street”, “choosing an article”, or “shoplifting” as the type of act.

Furthermore, the recognizing unit 102 makes the presenting unit 105 present the recognized description of the attribute of the person and type of act of the person as recognition results by outputting the above-described presentation signal to the presenting unit 105. In addition, the recognizing unit 102 makes the presenting unit 105 present the form image used for recognition by the output of the presentation signal.

Moreover, when obtaining the operation signal from the input unit 106, the recognizing unit 102 accepts change of at least one of the description of the attribute and the type of act which are included in the presented recognition results in accordance with the operation signal. That is, the recognizing unit 102 changes at least one of the description of the attribute and the type of act which are included in the presented recognition results in accordance with the operation signal.

Furthermore, the recognizing unit 102 generates recognition result information including image identifying information for identifying a taken image and indicating the recognition results for the taken image, and outputs the recognition result information to the history creating unit 104 and the judging unit 103a. It is to be noted that, if the above-mentioned change is accepted, the recognition results indicated by this recognition result information are the changed recognition results.

The history creating unit 104 stores the description of the attribute of the object and the type of act of the object, which were recognized by the recognizing unit 102, in the recognition result storing unit 301 which is a database. That is, the history creating unit 104 stores the recognition result information output from the recognizing unit 102 in the recognition result storing unit 301. Here, if change of at least one of the description of the attribute and the type of act which are included in the recognition results presented by the presenting unit 105 is accepted, the history creating unit 104 stores the changed recognition results in the recognition result storing unit 301 which is a database.

The judging unit 103a judges whether or not the frequency of occurrence of an act of the type recognized by the recognizing unit 102 is less than a previously set threshold value by referring to the recognition result storing unit 301 which is a database. Here, if change of at least one of the description of the attribute and the type of act which are included in the recognition results presented by the presenting unit 105 is accepted, the judging unit 103a judges whether or not the frequency of occurrence of an act of a type included in the changed recognition results is less than the threshold value. In other words, if change of the type of act included in the recognition results presented by the presenting unit 105 is accepted, the judging unit 103a judges whether or not the frequency of occurrence of an act of the changed type is less than the threshold value.

Specifically, when obtaining the recognition result information from the recognizing unit 102, the judging unit 103a identifies the type of act included in the recognition result information thus obtained. Then, the judging unit 103a derives the number of pieces of recognition result information including the identified type of act, which is stored in the recognition result storing unit 301, as the frequency of occurrence. The judging unit 103a then judges whether or not the derived frequency of occurrence is less than the threshold value and notifies the CG creation instructing unit 103b of the judgment result along with the identification result information.

If the judgment result notified by the judging unit 103a indicates that the frequency of occurrence is less than the threshold value, the CG creation instructing unit 103b outputs a CG creation instruction to the CG creating device 200. In so doing, the CG creation instructing unit 103b outputs the recognition result information to the CG creating device 200 along with the CG creation instruction.

That is, if the judging unit 103a judges that the frequency of occurrence is less than the threshold value, the CG creation instructing unit 103b outputs, to the CG creating device 200, an instruction to create, as learning data, CG data describing a state in which the object having the attribute whose description is different from the description of the attribute recognized by the recognizing unit 102 is doing an act of the recognized type based on the taken image. Here, if change of at least one of the description of the attribute and the type of act which are included in the recognition results presented by the presenting unit 105 is accepted, the CG creation instructing unit 103b outputs an instruction to create CG data describing a state in which the object having the attribute whose description is different from the description of the attribute included in the changed recognition results is doing an act of a type included in the changed recognition results.

The CG creating device 200 is configured with a computer and so forth and creates CG data of a person when obtaining the recognition result information from the CG creation instructing unit 103b along with the CG creation instruction.

Specifically, the CG creating device 200 obtains, from the image taking unit 101, the skeleton information corresponding to the taken image identified based on the image identifying information included in the recognition result information. The CG creating device 200 changes the description of an attribute of a person indicated by the recognition result information and generates, as attribute act information, recognition result information including the changed description of the attribute. Then, the CG creating device 200 creates CG data describing a state in which a person having the attribute of the changed description is doing an act of the type indicated by the recognition result information. That is, the CG creating device 200 creates CG data of a person having the attribute whose description is different from the description of the attribute indicated by the obtained recognition result information based on the skeleton or joints indicated by the skeleton information. Then, the CG creating device 200 stores the created CG data in the CG data storing unit 302 as learning data. In so doing, the CG creating device 200 stores the attribute act information indicating the attribute with the different description in the CG data storing unit 302 along with the CG data.

The recognition result storing unit 301 is a recording medium, such as memory or a hard disk, with a recording area for recording the recognition result information which is output from the recognizing unit 102 via the history creating unit 104.

The CG data storing unit 302 is a recording medium, such as memory or a hard disk, with a recording area for recording the CG data and the attribute act information created by the CG creating device 200.

Moreover, by using the CG data created in response to the output of the instruction by the CG creation instructing unit 103b, the recognizing unit 102 learns the relationship between an image described by the CG data and the description of the attribute of the object and the type of act of the object. That is, the recognizing unit 102 upgrades the recognition model by using the CG data and the attribute act information corresponding to the CG data, which are stored in the CG data storing unit 302, as learning data.

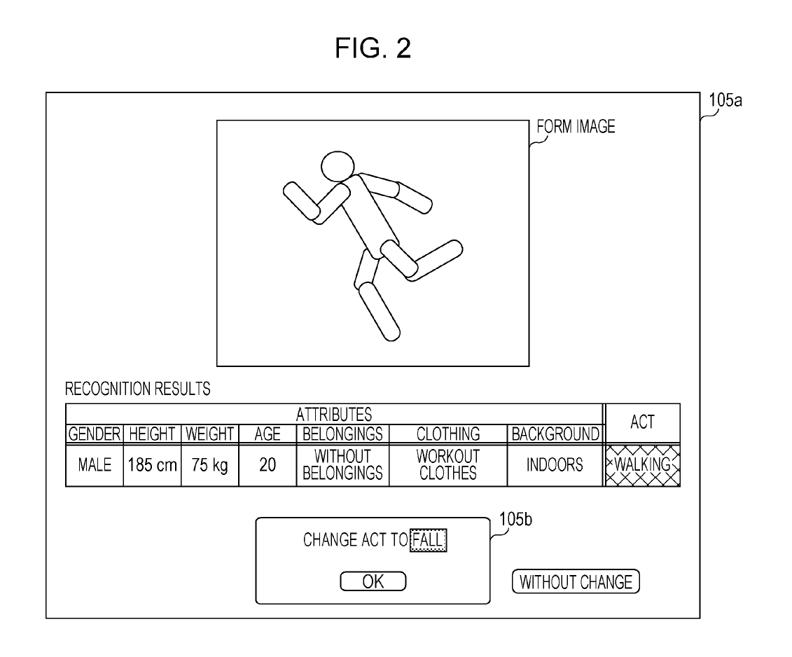

FIG. 2 is a diagram depicting an example of a screen which is displayed by the presenting unit 105.

When obtaining the presentation signal from the recognizing unit 102, the presenting unit 105 presents a screen 105a in accordance with the presentation signal. The screen 105a includes the form image included in the taken image used for recognition performed by the recognizing unit 102 and the recognition results (the description of the attribute of a person and the type of act of the person) for the taken image.

For example, the recognition results include descriptions of a plurality of attributes of the person and the type of act of the person. More specifically, the plurality of attributes are, for example, gender, height, weight, age, belongings, clothing, and background. Descriptions of these attributes are, for example, gender “male”, height “185 cm”, weight “75 kg”, age “20”, belongings “without belongings”, clothing “workout clothes”, and background “indoors”. Moreover, the type of act is, for example, “walking”.

The user reads the recognition results presented by the presenting unit 105 while comparing the recognition results with the form image. Then, if the user desires to change any of the descriptions the plurality of attributes and the type of act included in the recognition results, the user selects a region in which the description or type is displayed by operating the input unit 106. The recognizing unit 102 makes the presenting unit 105, for example, change the color of the selected region and display, in the screen 105a, a window 105b that accepts change of the description or type corresponding to the region.

Specifically, if the region of the type of act “walking” is selected, the presenting unit 105 displays the window 105b that accepts change of the type of act “walking” in the screen 105a.

The user operates the input unit 106 to display “fall”, for example, as the type of act in the window 105b and selects a button indicating “OK”, for example. In response thereto, the recognizing unit 102 changes the type of act included in the recognition results from “walking” to “fall”. Then, the recognizing unit 102 presents the changed recognition results, generates the recognition result information including the image identifying information corresponding to the form image, and outputs the recognition result information to the history creating unit 104 and the judging unit 103a. If change has not been made to the recognition results presented by the presenting unit 105, the recognizing unit 102 displays the unchanged recognition results and generates the recognition result information including the image identifying information corresponding to the form image. Then, the recognizing unit 102 outputs the recognition result information to the history creating unit 104 and the judging unit 103a.

A change to the recognition results using the input unit 106 and the presenting unit 105, which has been described above, is made to correct an error when an error is found in the original recognition results. Alternatively, when the description of an attribute or the type of act included in the original recognition result is “unknown” or “others”, for example, the above-described change is made to attach a correct label to the description or type recognized as “unknown” or “others”.

By making such a change to the recognition results, it is possible to effectively prevent inappropriate CG data from being created.

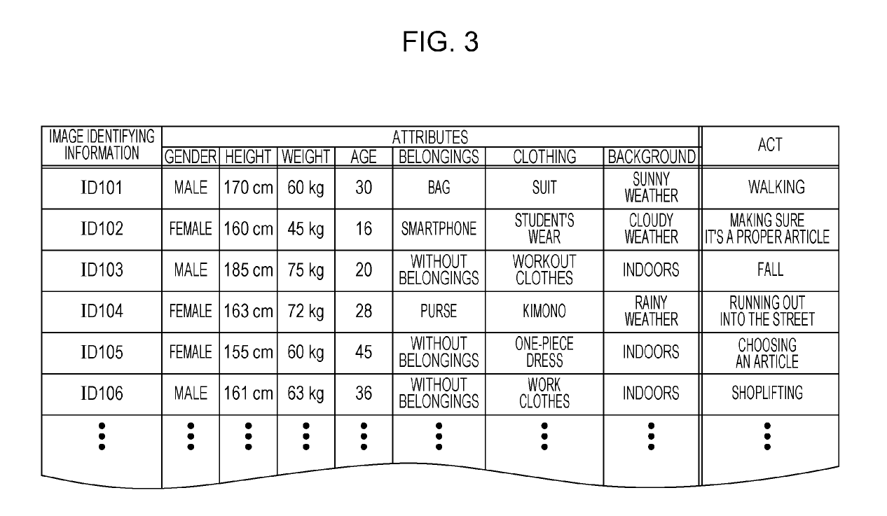

FIG. 3 is a diagram depicting an example of the recognition results stored in the recognition result storing unit 301.

Every time the recognition result information is generated by the recognizing unit 102, the history creating unit 104 stores the recognition result information in the recognition result storing unit 301. As a result, the history of the recognition results is created. As depicted in FIG. 3, the recognition result information includes the image identifying information and contains descriptions of a plurality of attributes of a person recognized with respect to a taken image identified by the image identifying information and the type of act of the person. For instance, the recognition result information includes image identifying information “ID101” and contains, as descriptions of attributes, gender “male”, height “170 cm”, weight “60 kg”, age “30”, belongings “bag”, clothing “suit”, and background “sunny weather” recognized with respect to the taken image identified by the image identifying information. Furthermore, the recognition result information contains, as the type of act, an act “walking” recognized with respect to the taken image identified by the image identifying information “ID101”. Every time such recognition result information is generated, the recognition result information is stored in the recognition result storing unit 301 as a history.

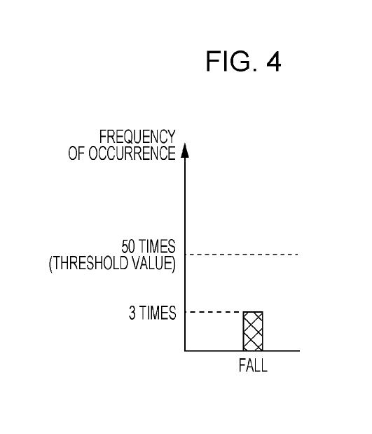

FIG. 4 is a diagram depicting an example of the frequency of occurrence of an act which is stored in the recognition result storing unit 301.

When obtaining the recognition result information from the recognizing unit 102, the judging unit 103a refers to the recognition result storing unit 301 and derives the frequency of occurrence of an act of the type indicated by the recognition result information. For example, the judging unit 103a identifies “fall” as the type of act indicated by the obtained recognition result information. In this case, the judging unit 103a derives the number of pieces of recognition result information indicating “fall” as the type of act of all the pieces of recognition result information stored in the recognition result storing unit 301 as the frequency of occurrence of an act of that type. For instance, the judging unit 103a derives the frequency of occurrence “3 times”.

Then, the judging unit 103a compares the derived frequency of occurrence “3 times” of “fall” with a previously set threshold value (for example, 50 times). That is, the judging unit 103a judges whether or not the frequency of occurrence is less than the threshold value.

Here, if the judging unit 103a judges that the frequency of occurrence is less than the threshold value, the CG creation instructing unit 103b outputs, to the CG creating device 200, a CG creation instruction to create CG data corresponding to the type of act “fall”. In so doing, the CG creation instructing unit 103b obtains the recognition result information from the recognizing unit 102 via the judging unit 103a and outputs the CG creation instruction to the CG creating device 200 along with the recognition result information.

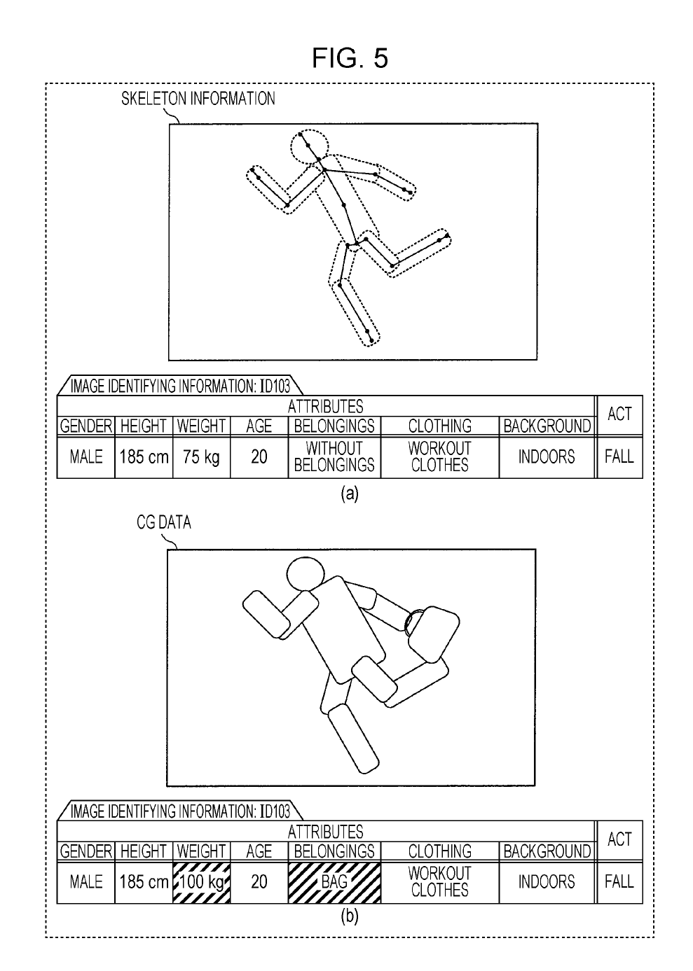

FIG. 5 is a diagram for explaining processing of the CG creating device 200.

When obtaining the recognition result information from the CG creation instructing unit 103b along with the CG creation instruction, the CG creating device 200 requests the skeleton information generated from the taken image identified by the image identifying information included in the recognition result information from the image taking unit 101. In response to the request from the CG creating device 200, the image taking unit 101 outputs the skeleton information to the CG creating device 200.

When obtaining the skeleton information from the image taking unit 101, based on the three-dimensional position of the skeleton or joints of a person indicated by the skeleton information, the CG creating device 200 creates CG data of the person. In so doing, the CG creating device 200 changes the description of at least one of the plurality of attributes indicated by the recognition result information obtained from the CG creation instructing unit 103b and creates CG data of a person in accordance with the changed description of the attribute.

For example, as depicted in FIG. 5(a), the CG creating device 200 obtains the skeleton information and the recognition result information containing weight “75 kg” and belongings “without belongings” as the descriptions of attributes. Then, as depicted in FIG. 5(b), the CG creating device 200 changes the weight “75 kg” to “100 kg” and changes the belongings “without belongings” to “bag”. Furthermore, the CG creating device 200 creates CG data of a person in accordance with the recognition result information including the changed descriptions of the weight and belongings. That is, the CG creating device 200 creates, as CG data, an image of a person who possesses each of gender “male”, height “185 cm”, weight “100 kg”, age “20”, belongings “bag”, clothing “workout clothes”, and background “indoors” as a description of an attribute and is doing an act “fall”. Then, the CG creating device 200 stores the created CG data in the CG data storing unit 302. In so doing, the CG creating device 200 stores, as the attribute act information, the recognition result information whose descriptions of attributes have been changed in the CG data storing unit 302 in a state in which the information is associated with the CG data.

As a result, it is possible to obtain not only the taken image (specifically, the form image), which was obtained by the image taking unit 101, of a person who is doing a peculiar act “fall” but also CG data describing a person having attributes whose descriptions are different from those of the above person is doing the act “fall”. This makes it possible to obtain, as learning data, a large amount of appropriate CG data which is an image of a person who is doing the peculiar act “fall”.

Furthermore, the recognizing unit 102 performs relearning by using the CG data and the attribute act information associated with the CG data, which are stored in the CG data storing unit 302, as learning data. As a result, it is possible to increase the accuracy of recognition of peculiar acts.

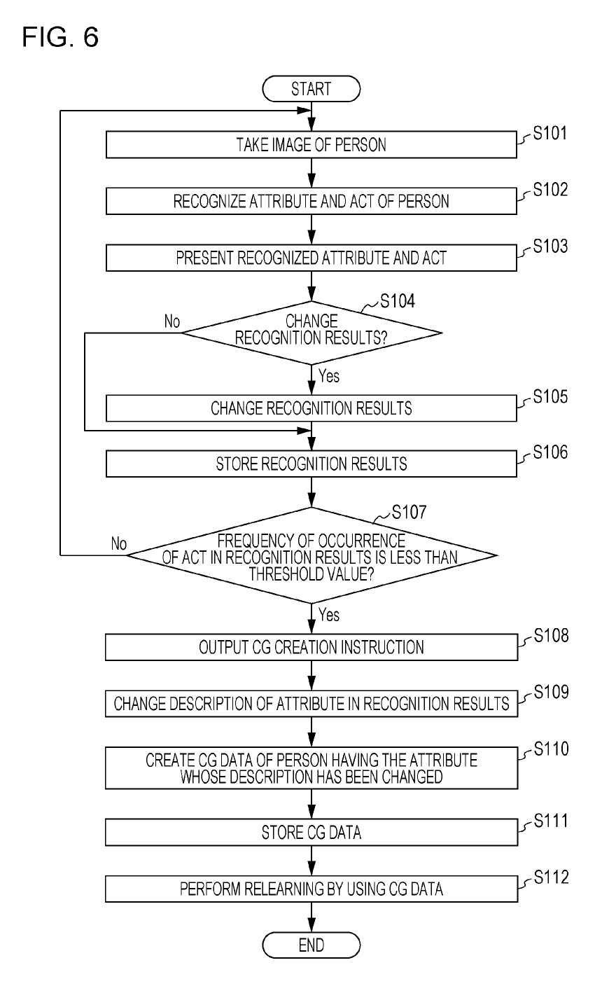

FIG. 6 is a flowchart illustrating processing operations of the learning data creating system 10 in the present embodiment.

First, the image taking unit 101 obtains a taken image by taking an image of a person (Step S101). Then, the recognizing unit 102 recognizes a description of an attribute of the person and the type of act of the person based on the taken image (Step S102) and makes the presenting unit 105 present the recognized description of the attribute of the person and the type of act of the person as recognition results (Step S103).

Based on the operation signal from the input unit 106, the recognizing unit 102 judges whether or not a change is made to the presented recognition results (Step S104). Here, if the recognizing unit 102 judges that a change is made to the recognition results as a result of the button indicating “OK” depicted in FIG. 2, for example, being selected (Yes in Step S104), the recognizing unit 102 changes the recognition results based on the operation signal (Step S105).

If a judgment is made in Step S104 that a change is not made to the recognition results (No in Step S104), the history creating unit 104 stores the recognition result information indicating the unchanged recognition results in the recognition result storing unit 301. Moreover, if the recognition results are changed in Step S105, the history creating unit 104 stores the recognition result information indicating the changed recognition results in the recognition result storing unit 301 (Step S106).

Next, the judging unit 103a judges whether or not the frequency of occurrence of an act of the type indicated by the recognition result information is less than a threshold value (Step S107). Here, if a judgment is made that the frequency of occurrence is greater than or equal to the threshold value (No in Step S107), the learning data creating system 10 repeats the processing from Step S101. On the other hand, if a judgment is made that the frequency of occurrence is less than the threshold value (Yes in Step S107), the CG creation instructing unit 103b outputs a CG creation instruction to the CG creating device 200 along with the recognition result information (Step S108).

The CG creating device 200 changes the description of the attribute indicated by the recognition result information output from the CG creation instructing unit 103b (Step S109) and creates CG data of a person having the attribute whose description has been changed (Step S110). Then, the CG creating device 200 stores the created CG data in the CG data storing unit 302 along with the attribute act information indicating the changed description of the attribute (Step S111).

The recognizing unit 102 performs relearning by using the CG data and the attribute act information corresponding to the CG data, which are stored in the CG data storing unit 302 (Step S112).

Steps S101 to S108 and S112 described above are steps included in the processing operations of the learning data creation supporting device 100, that is, a learning data creation supporting method. Moreover, Steps S109 to S111 described above are processing operations of the CG creating device 200.

### [Effects and Others]

As described above, in the learning data creation supporting method of the present embodiment, the judging unit 103a judges whether or not the frequency of occurrence of an act of the type recognized based on a taken image is less than a threshold value. Thus, it is possible to automatically extract a taken image in which the object which is a person, for example, is doing an act of a type whose frequency of occurrence is low, such as “running out into the street”, “fall”, or “shoplifting”, that is, a peculiar act. Furthermore, since the CG creation instructing unit 103b outputs an instruction to create CG data, it is possible to generate, as learning data, CG data describing a state in which a person having the attribute whose description is different from the description of the attribute of the person in the taken image is doing the peculiar act. That is, it is possible to create, as learning data, a large amount of CG data describing states in which the persons with different descriptions of the attribute are doing the peculiar act. This makes it possible to create and collect appropriate learning data for peculiar acts and so forth.

Moreover, since the recognizing unit 102 performs learning, such as deep learning using the created CG data, as relearning, even when an object whose image has not been taken before is doing a peculiar act, it is possible to increase the accuracy of recognition of a taken image of the object.

In addition, even when there is an error in the recognition results, it is possible to correct the error by change by using the presenting unit 105 and the input unit 106. Moreover, even when the type of act is recognized as “unknown” or “others”, it is possible to correct “unknown” or “others” to a correct type of act. This makes it possible to create and collect more appropriate CG data and thereby achieve a further increase in the accuracy of recognition of peculiar acts.

Furthermore, since the image taking unit 101 generates the skeleton information and recognition is performed based on the skeleton information, it is possible to recognize the type of act of a person more appropriately.

In addition, since the skeleton information is output from the image taking unit 101, the CG creating device 200 can use the skeleton information in creating CG data. As a result, it is possible to create appropriate CG data by attaching various attributes to the skeleton or joints of a person indicated by the skeleton information.

### (Other Embodiments)

While the learning data creation supporting method and so forth according to an aspect of the present disclosure have been described based on the embodiment, the present disclosure is not limited to this embodiment. What is obtained by making various modifications, which a person skilled in the art can conceive of, to the embodiment may be included in the scope of the present disclosure without departing from the spirit of the present disclosure.

For example, in the above-described embodiment, the presenting unit 105 and the input unit 106 perform presentation and change, for instance, of the recognition results, but the presentation and change may not be performed.

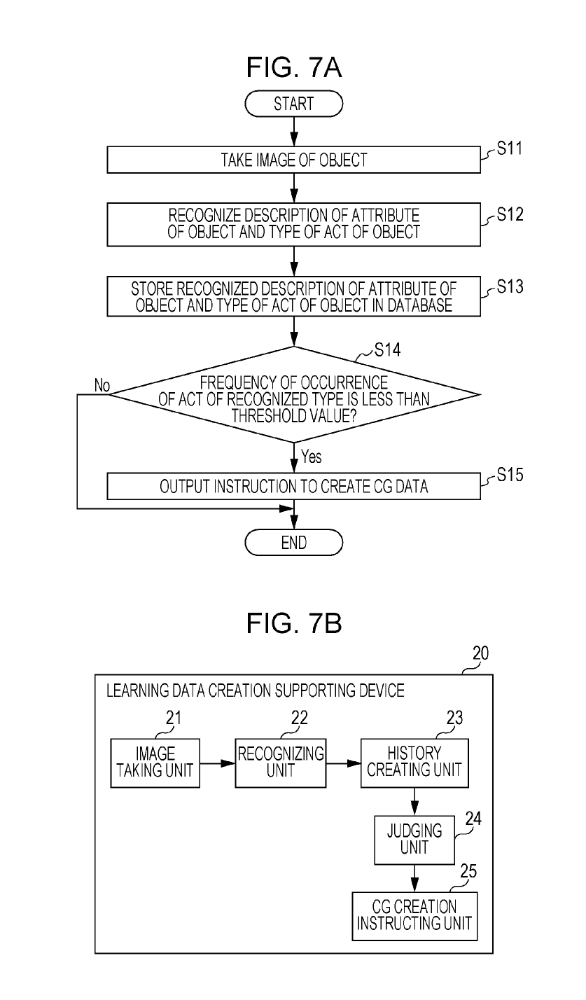

FIG. 7A is a flowchart illustrating a learning data creation supporting method according to an aspect of the present disclosure.

The learning data creation supporting method according to the aspect of the present disclosure is a method that supports creation of learning data and includes Steps S11 to S15. In Step S11, a taken image is obtained by taking an image of an object. In Step S12, based on the taken image, a description of an attribute of the object and the type of act of the object are recognized. In Step S13, the recognized description of the attribute of the object and type of act of the object are stored in a database. In Step S14, by referring to the database, a judgment as to whether not the frequency of occurrence of an act of the recognized type is less than a previously set threshold value is made. In Step S15, if a judgment is made in Step S14 that the frequency of occurrence is less than the threshold value, an instruction to create, as learning data, CG data describing a state in which the object having the attribute whose description is different from the recognized description of the attribute is doing the act of the recognized type based on the above-described taken image is output.

FIG. 7B is a block diagram depicting the functional configuration of a learning data creation supporting device according to an aspect of the present disclosure.

A learning data creation supporting device 20 according to the aspect of the present disclosure is a device that supports creation of learning data and includes an image taking unit 21, a recognizing unit 22, a history creating unit 23, a judging unit 24, and a CG creation instructing unit 25. The image taking unit 21 obtains a taken image by taking an image of an object. The recognizing unit 22 recognizes a description of an attribute of the object and the type of act of the object based on the taken image. The history creating unit 23 stores the recognized description of the attribute of the object and type of act of the object in a database. By referring to the database, the judging unit 24 judges whether or not the frequency of occurrence of an act of the recognized type is less than a previously set threshold value. If a judgment is made that the frequency of occurrence is less than the threshold value, the CG creation instructing unit 25 outputs an instruction to create, as learning data, CG data describing a state in which the object having the attribute whose description is different from the recognized description of the attribute is doing the act of the recognized type based on the above-described taken image.

With the learning data creation supporting method depicted in FIG. 7A and the learning data creation supporting device 20 depicted in FIG. 7B, it is also possible to obtain workings and effects similar to those of the embodiment described above. That is, it is possible to create, as learning data, a large amount of CG data describing states in which the persons with different descriptions of an attribute are doing a peculiar act. This makes it possible to create and collect appropriate learning data for peculiar acts and so forth.

In the learning data creation supporting method depicted in FIG. 7A, an image of an object is taken in Step S11, but a taken image including the object may be obtained without taking an image of the object. Moreover, the learning data creation supporting device 20 depicted in FIG. 7B includes the image taking unit 21, but the learning data creation supporting device 20 may not include the image taking unit 21. In this case, the recognizing unit 22 of the learning data creation supporting device 20 obtains a taken image from the image taking unit 21 provided outside the learning data creation supporting device 20 via a wireless or wire communication medium, for example.

Furthermore, in the above-described embodiment, an image of a person is taken as an object and a description of an attribute of the person and the type of act of the person are recognized, but the object may be any body other than the person as long as the body is a body that moves. For instance, the object may be a vehicle. In this case, as a description of an attribute of the vehicle, a type “passenger car” or “truck”, for example, may be recognized, and, as the type of act of the vehicle, “sudden starting”, “sudden braking”, or “skid”, for example, may be recognized.

Moreover, in the above-described embodiment, the skeleton information is generated from a distance image and the skeleton information is used in recognition of a description of an attribute of a person and the type of act of the person, but the skeleton information may not be generated and may not be used in recognition. In such a case, a description of an attribute of a person and the type of act of the person may be recognized only by using a form image.

In each embodiment described above, each component element may be configured with dedicated hardware or may be implemented as a result of a software program which is suitable for each component element being executed. Each component element may be implemented as a result of a program executing unit such as a CPU or processor reading and executing a software program recorded on a recording medium such as a hard disk or semiconductor memory. Here, software that implements each of the learning data creation supporting device and the learning data creating system of each embodiment described above makes a computer execute each step of the flowchart depicted in FIG. 6 or 7A.

The following cases are also included in the present disclosure,

(1) Each device described above is specifically a computer system configured with a microprocessor, ROM, RAM, a hard disk unit, a display unit, a keyboard, a mouse, and so forth. In the RAM or hard disk unit, a computer program is stored. As a result of the microprocessor operating in accordance with the computer program, each device performs the function thereof. Here, the computer program is configured to perform the prescribed function by combining a plurality of instruction codes, each indicating a command to the computer.

(2) Part or all of the component elements forming each device described above may be configured with one system large-scale integration (LSI). The system LSI is a super-multifunctional LSI produced by mounting a plurality of components on one chip and, specifically, is a computer system including a microprocessor, ROM, RAM, and so forth. In the RAM, a computer program is stored. As a result of the microprocessor operating in accordance with the computer program, the system LSI performs the function thereof.

(3) Part or all of the component elements forming each device described above may be configured with an IC card or single module that is detachable and attachable from and to the device. The IC card or module is a computer system configured with a microprocessor, ROM, RAM, and so forth. The IC card or module may include the above-described super-multifunctional LSI. As a result of the microprocessor operating in accordance with a computer program, the IC card or module performs the function thereof. The IC card or module may have tamper resistance.

(4) The present disclosure may be the methods described above. Moreover, the present disclosure may be a computer program that implements these methods by a computer or may be a digital signal generated by the computer program.

Moreover, the present disclosure may be what is obtained by recording the computer program or the digital signal on a computer-readable recording medium, such as a flexible disk, a hard disk, a CD-ROM, an MO, a DVD, a DVD-ROM, a DVD-RAM, a Blu-ray Disc™ (BD), or a semiconductor memory. Furthermore, the present disclosure may be the digital signal recorded on these recording media.

Furthermore, the present disclosure may be what transmits the computer program or the digital signal via an electric communication line, a wireless or wire communication line, a network typified by the Internet, data broadcasting, or the like.

In addition, the present disclosure may be a computer system including a microprocessor and memory, the memory may store the computer program, and the microprocessor may operate in accordance with the computer program.

Moreover, by transferring the program or the digital signal in a state in which the program or the digital signal is recorded on the recording medium or transferring the program or the digital signal via the network or the like, execution may be performed by another independent computer system.

The present disclosure makes it possible to create appropriate learning data and can be used in, for example, a device or system that creates learning data used for learning the relationship between an image of a person and a description of an attribute of the person and the type of act of the person.

What is claimed is:

1. A method comprising:
recognizing, based on a taken image obtained by taking an image of an object, a description of an attribute of the object and a type of act of the object;
storing the recognized description of the attribute of the object and type of act of the object in a database;
judging whether a frequency of occurrence of an act of the recognized type is less than a previously set threshold value by referring to the database; and
outputting, if a judgment is made that the frequency of occurrence is less than the threshold value, an instruction to create, as learning data, computer graphics (CG) data describing a state in which the object having the attribute whose description is different from the recognized description of the attribute is doing the act of the recognized type based on the taken image.

2. The method according to claim 1, wherein
the taken image is an image obtained by taking an image of a person as the object, and
in the recognizing, a description of at least one of an age, gender, physique, clothing, belongings, and background of the person is recognized as the description of the attribute.

3. The method according to claim 1, further comprising:
learning a relationship between an image described by the CG data and the description of the attribute of the object and the type of act of the object by using the CG data created in response to the output of the instruction.

4. The method according to claim 1, further comprising:
presenting the recognized description of the attribute of the object and type of act of the object as recognition results; and
accepting change of at least one of the description of the attribute and the type of act which are included in the presented recognition results, wherein
in the storing, the changed recognition results are stored in the database,
in the judging, a judgment as to whether or not a frequency of occurrence of an act of a type included in the changed recognition results is less than the threshold value is made, and
in the outputting, an instruction to create the CG data describing a state in which the object having the attribute whose description is different from the description of the attribute included in the changed recognition results is doing the act of the type included in the changed recognition results is output.

5. The method according to claim 1, wherein
the taken image includes a form image indicating a form and brightness of a person as the object and a distance image indicating a distance to each body part in the person, and
in the recognizing, recognition is performed based on the form image and skeleton information indicating a skeleton or joints of the person and generated from the distance image.

6. The method according to claim 5, further comprising:
outputting the skeleton information to a device that creates the CG data.

7. A device comprising:
a recognizer that recognizes, based on a taken image obtained by taking an image of an object, a description of an attribute of the object and a type of act of the object;
a history creator that stores the recognized description of the attribute of the object and type of act of the object in a database;
a judger that judges whether a frequency of occurrence of an act of the recognized type is less than a previously set threshold value by referring to the database; and
a CG creation instructor that outputs, if the judger judges that the frequency of occurrence is less than the threshold value, an instruction to create, as learning data, computer graphics (CG) data describing a state in which the object having the attribute whose description is different from the recognized description of the attribute is doing the act of the recognized type based on the taken image.

8. A non-transitory computer-readable recording medium on which a program is recorded, wherein
when the program is executed by a computer, the program makes the computer execute a method including
recognizing, based on a taken image obtained by taking an image of an object, a description of an attribute of the object and a type of act of the object,
storing the recognized description of the attribute of the object and type of act of the object in a database,
judging whether a frequency of occurrence of an act of the recognized type is less than a previously set threshold value by referring to the database, and
outputting, if a judgment is made that the frequency of occurrence is less than the threshold value, an instruction to create, as learning data, computer graphics (CG) data describing a state in which the object having the attribute whose description is different from the recognized description of the attribute is doing the act of the recognized type based on the taken image.
